(19) United States
(12) Patent Application Publication
(10) Pub. No.: US 2026/0241817 A1
(43) Pub. Date: Aug. 20, 2026

(54) Vehicle High Voltage Electronics Box

(71) Applicant: Schaeffler Technologies AG & Co. KG, Herzogenaurach (DE)

(72) Inventors: Aniket Anand, Windsor (CA); Wesam Taha, Windsor (CA); Yicheng Wang, Windsor (CA)

(73) Assignee: Schaeffler Technologies AG & Co. KG, Herzogenaurach (DE)

(21) Appl. No.: 19/490,625

(22) PCT Filed: May 9, 2024
(86) PCT No.: PCT/US2024/028515

§ 371 Date: Dec. 5, 2025

Related U.S. Application Data
(60) Provisional application No. 63/500,963, filed on May 9, 2023.
(60) Provisional application No. 63/507,711, filed on Jun. 12, 2023.
(60) Provisional application No. 63/610,237, filed on Dec. 14, 2023.
(60) Provisional application No. 63/565,466, filed on Mar. 14, 2024.

(30) Foreign Application Priority Data
Dec. 14, 2023 (US) 6361037

(51) Int. Cl. B60L 53/24; B60L 1/00; B60L 50/51

(52) U.S. Cl. CPC B60L 53/24; B60L 1/00; B60L 50/51; B60L 2210/10; B60L 2210/30; B60L 2210/40; B60L 2220/42; B60L 2240/526; B60L 2240/527; B60L 2240/529; B60L 2260/40

(57) ABSTRACT

The disclosure provides a system and a method of operating the system supported by an electric vehicle (EV). The method includes receiving input data from an input. When the input data is indicative of the EV being in a driving status, the method includes executing a first mode of operation causing a high voltage battery supported by the EV to supply power to a motor. When the input data is indicative of the EV being connected to an alternating voltage source, the method includes executing a second mode of operation causing the motor and an inverter to behave as a two-phased interleaved PFC circuit and to charge the high voltage battery.

### TECHNICAL FIELD

The disclosure relates to a vehicle high voltage electronics box that functionally and electrically integrates several electrical power electronics.

### BACKGROUND

An electric car, an electric vehicle (EV), or a battery electric vehicle are all used to describe automobiles powered by one or more electric motors using energy stored in one or more rechargeable energy storage units such as batteries or other electricity storage devices such as supercapacitors. Electric vehicles (EV) have one or more complex networks of power electronics where each includes converters, inverters, and control systems. Each complex network of power electronics converts and manages electrical energy to drive the vehicle, charge the vehicle battery, and ensure overall system efficiency. To fulfill such functionalities, various power electronics subsystems, packaged individually, are found under the EV vehicle hood.

Current market projections anticipate a highly integrated power electronics system in the next generation of battery electric vehicles (BEV). Overall reduction in size, cost, and weight of power electronics converters, onboard chargers (OBC), traction inverters, and auxiliary power modules (APM) are some of the key factors to achieve the highly integrated system. The transition from low-switching frequency converters to high-switching frequency converters has drastically reduced the size and cost of the magnetics in the system. Moreover, the hybrid solution with combinations of different wide band gap devices like SiC and GaN at different stages of power conversion offers further cost savings and efficiency improvement.

Some of the known solutions to the above-mentioned deficiencies are described in U.S. Patent Application Publication No. 201 10221363A1 which relates to a combined electric device for powering and charging and proposes a device for the open-end winding machine. The machine includes three H bridges and operates in two operating modes: powering mode in which two inverters are used to feed the alternating current to open end winding machine and charging mode when motor windings are used as an inductor to feed three-phase power from the grid to the battery.

Another solution is discussed in U.S. Patent Application Publication No. 20190126763A1 which relates to a combined electric device for powering and charging. This application claims a charging system utilizing a six-phase machine with two sets of galvanically isolated windings. A vehicle includes two inverters and three-phase inductors. In this case, isolation is provided between battery and charge port in the proposed charging system using six-phase machine.

Another solution is discussed in U.S. Patent Application Publication No. 20170305283A1 which relates to an integrated charger for vehicles. This application provides a traction system with an additional inductor in series with motor winding to realize a DC-DC converter. Two additional inductors with two-phase windings are realized as a DC-DC converter. Buck-boost DC-DC converter is formed using additional inductors and motor winding for charging.

Yet another solution is discussed in U.S. Patent Application Publication No. 20130307333A1 which relates to an inverter-charger combined device for electric vehicles. This application provides a system with an additional single-phase rectifier and buck converter. An inverter charger combined device utilizes the three-phase motor windings. The device claims the functionality of high voltage charger, low voltage charger, and inverter operation.

The known described systems discuss a traditional battery electric vehicle system which includes independent power electronics conversion systems that includes the traction inverter for driving the electric machine, an OBC for charging the high voltage (HV) battery from the AC grid, a DC boost charger for charging the HV battery from the legacy 400 V DC charger, and an APM for feeding different auxiliary loads.

Therefore, there is a need for a system that functionally and electrically integrates several independent power conversion systems into one box.

### SUMMARY

One aspect of the disclosure provides a system operating in at least two modes of operation based on an input. The system is supported by an electric vehicle (EV). The system includes: an input that receives input data from one or more sensors; a motor; and an inverter connected to the motor. Additionally, the system includes an inverter DC-link capacitor connected to the inverter and a DC-DC converter connected to the DC-link capacitor and a high voltage battery.

Implementations of the disclosure may include one or more of the following optional features. In some implementations, the system supports a low voltage load. The DC-DC converter includes an isolated DC-DC Triple active bridge (TAB) having three bridges, a first bridge connected to the inverter DC-link capacitor, a second bridge connected to the low voltage load, and a third bridge connected to the high voltage battery. In some examples, when the input data is indicative of the EV being in a driving status, the high voltage battery supplies power to the low voltage load and to the motor during a traction mode of operation.

In some implementations, the motor includes a first motor and a second motor; the inverter includes a first inverter and a second inverter; the inverter DC-link capacitor includes a first DC-link capacitor and a second DC-link capacitors; and the isolated DC-DC Triple active bridge (TAB) includes a first isolated DC-DC TAB and a second isolated DC-DC TAB.

In some examples, when the input data is indicative of the EV connected to an alternating voltage source, the motor and the inverter behave as a two-phased interleaved PFC circuit to convert alternating power from the alternating voltage source to direct power during an AC charging mode of operation. When the input data is indicative of the EV connected to a direct voltage source, the motor and the inverter behave as a two-phased interleaved boost converter circuit to boost direct power from the direct voltage source during a DC boost charging mode of operation.

In some implementations, the motor is a 3-Phase motor with neutral access point. The DC-link capacitor may be a split DC-link capacitor. In some examples, one or more sensors include voltage sensor, current sensors, and vehicle motion sensor.

Another aspect of the disclosure provides a method of operating a system in at least one of two modes of operation based on an input to the system. The system is supported by an electric vehicle. The method includes receiving input data from the input. When the input data is indicative of the EV being in a driving status, the method includes executing a first mode of operation causing a high voltage battery supported by the EV to supply power to a motor of the EV. Additionally, when the input data is indicative of the EV being connected to an alternating voltage source, the method includes executing a second mode of operation causing the motor and an inverter supported by the EV to behave as a two-phased interleaved PFC circuit (to convert alternating power from the alternating voltage source to direct power).

Implementation of this aspect of the disclosure may include one or more of the following optional features. In some implementations, when the input data is indicative of the EV being connected to a direct voltage source, the method includes executing a third mode of operation causing the motor and the inverter to behave as a two-phased interleaved boost converter circuit to boost direct power from the direct voltage source. During the third mode of operation, the high voltage battery is charged by direct power. The modes of operation are mutually exclusive.

In some examples, the two-phased interleaved boost converter circuit includes a first two-phased interleaved boost converter circuit and a second two-phased interleaved boost converter circuit.

In some implementations, the first mode of operation causes the high voltage battery to supply power to one or more low voltage loads by the EV. The first mode of operation may cause the high voltage battery to supply power to an additional motor of the EV. The two-phased interleaved PFC circuit may include a first two-phased interleaved PFC circuit and a second two-phased interleaved PFC circuit. In some examples, the input data includes at least one voltage sensor data, current sensor data, and vehicle motion sensor data.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary system supported by an electric vehicle.

FIGS. 2A and 2B are schematic views of the exemplary system supported by the electric vehicle shown in FIG. 1.

FIG. 3A is a schematic view of an exemplary circuit of the system of FIG. 1.

FIG. 3B is a schematic view of the circuit shown in FIG. 3A during a first mode of operation.

FIG. 3C is a schematic view of the circuit shown in FIG. 3A during a second mode of operation.

FIG. 3D is a schematic view of the circuit shown in FIGS. 3A and 2B during a third mode of operation.

FIGS. 4A-16B are schematic views of exemplary circuits of the system of FIGS. 1-2B.

FIG. 17 is a schematic view of an exemplary arrangement of operations for a method of operating the system of FIGS. 1-16B.

Like reference symbols in the various drawings indicate like elements.

### DETAILED DESCRIPTION

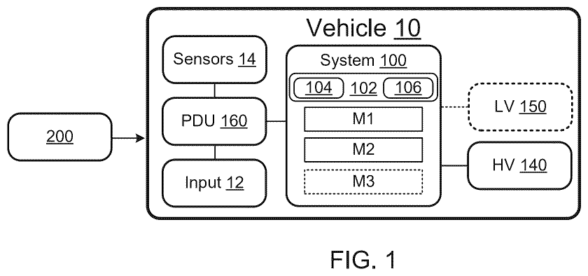

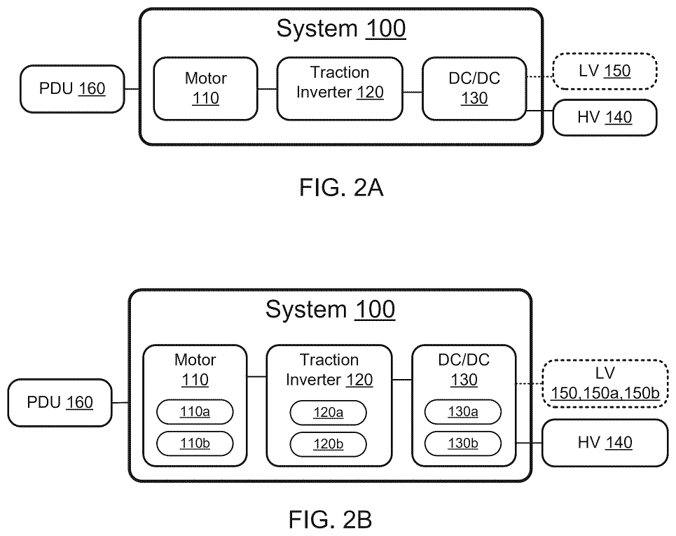

The disclosure provides a highly integrated system 100 supported by a vehicle 10 shown in FIGS. 1-2B. In some examples, the system 100 is a high voltage electronics box that functionally and electrically integrates several sub-systems of the vehicle 10. The system 100 includes independent power conversion sub-systems each supporting several electronics of a battery electric vehicle (BEV) 10. The system 100 supports an 800 Volt vehicle architecture, single or dual motor drives, single/split phase AC charging, DC boost charging, and LV (low voltage) DC-DC. In other words, the system 100 includes several power electronics conversion sub-systems that are part of the system 100, i.e., the HV electronics box, resulting in reduced size, cost, and weight of power electronics converters in the BEV 10 by having a single integrated system 100.

The system 100 integrates the following high voltage power electronics: traction inverter, on-board charger (OBC), DC boost charger, and high voltage (HV) to low voltage (LV) DC-DC converter. The traction inverter is essential to the system 100 since it converts a direct current (DC) supply from the vehicle's batteries into an alternating current (AC) output. The OBC, e.g., including AC charging circuits, converts AC power from external sources, such as residential outlets, to DC power that is used to charge the vehicle's battery pack. The DC Boost Charger converter steps up the voltage while stepping down the current from its input (supply) to its output (load). For example, the DC boost charger can boost the voltage from 400V to 800V. In addition, the LV DC-DC converter provides power flow from a high voltage, such as 800V, to low voltage such as 12V. The benefits of the system 100 includes having the OBC and traction inverter within one package; bidirectional AC and DC Boost charging utilizing inverter power module and motor winding; significant device volume and cost reduction; and following the automotive industry high integration trend. Additionally, the system 100 utilizes motor winding of the traction motor for AC and DC boost charging, without any modification to the conventional Y connected three phase motor. In some examples, the system 100 provides dual bank configuration for AC and DC boost charging resulting in scalable charging power.

The system 100 includes several levels of integration. A first level of integration includes a traction inverter and a PFC converter where all the inverter switches are reused to realize a single/split phase PFC converter for charging. Secondly, for the DC boost charging from 400 V DC source to 800 V DC, the same inverter switches are used to achieve an interleaved DC boost converter operating in continuous conduction mode. Thirdly, the magnetic integration where both HV DC-DC and LV DC-DC isolation is provided by a single three-port transformer. Lastly, and in some examples, motor windings are utilized as the PFC coil and the boost inductor, thus, further reducing the magnetic requirement. As such, the system 100 provides a significant volume and cost reduction.

The system 100 includes a controller 102 having a computing device (or processor) 104 (e.g., central processing unit having one or more computing processors) in communication with non-transitory memory 106 (e.g., a hard disk, flash memory, random-access memory) capable of storing instructions executable on the computing processor(s) 104. In some examples, the controller 102 executes a method for determining a mode of operation M1, M2, M3 of the system 100 based on one or more inputs 12. In some examples, the input 12 includes sensor data from one or more sensors 14 indicative of the vehicle motion, i.e., speed, angular speed, position, etc. The sensors 14 may include an inertial measurement unit (IMU) configured to measure the vehicle's linear acceleration (using one or more accelerometers) and rotational rate (using one or more gyroscopes). Additionally, the sensors 14 may include voltage and current sensors to determine if the vehicle 10 is being charged and the type of charging input (e.g., AC or DC).

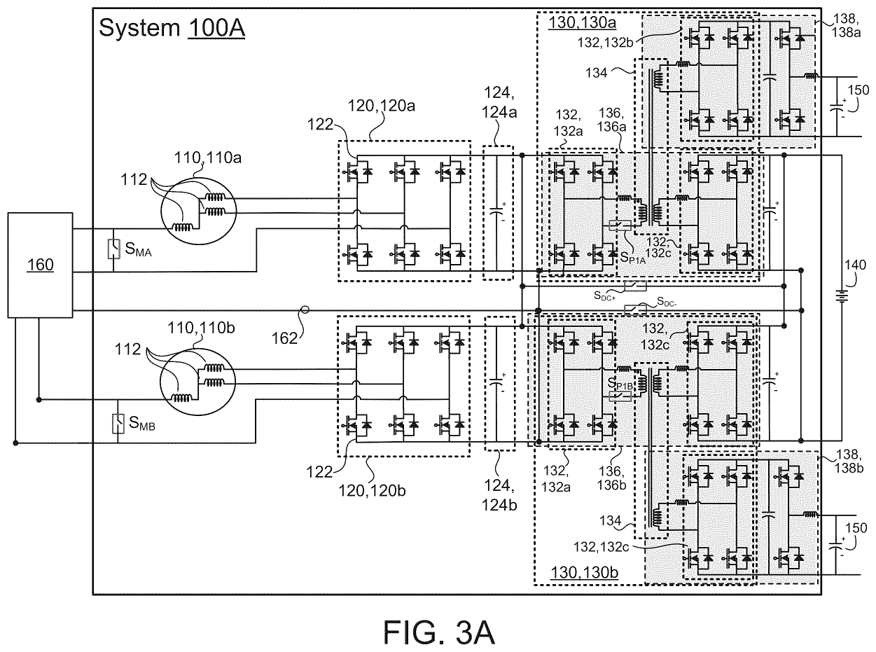

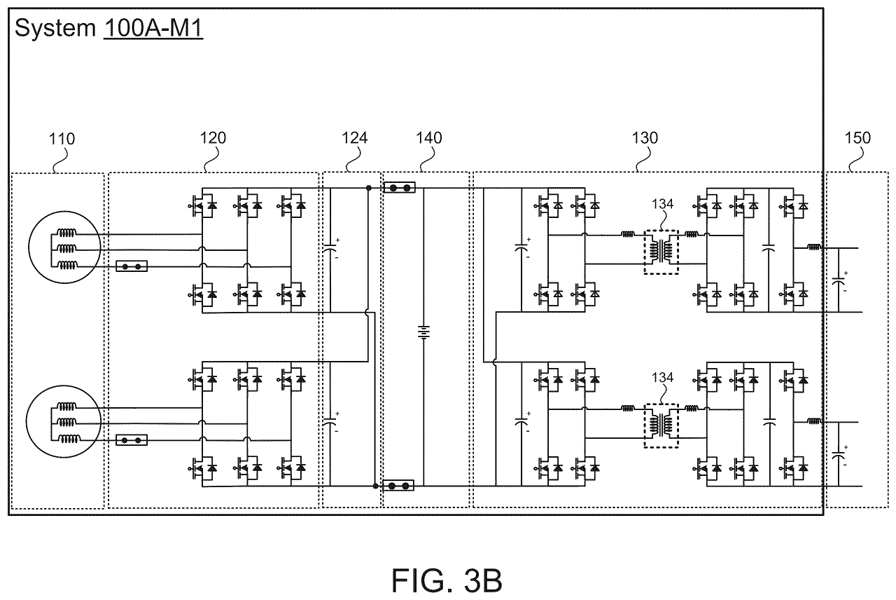

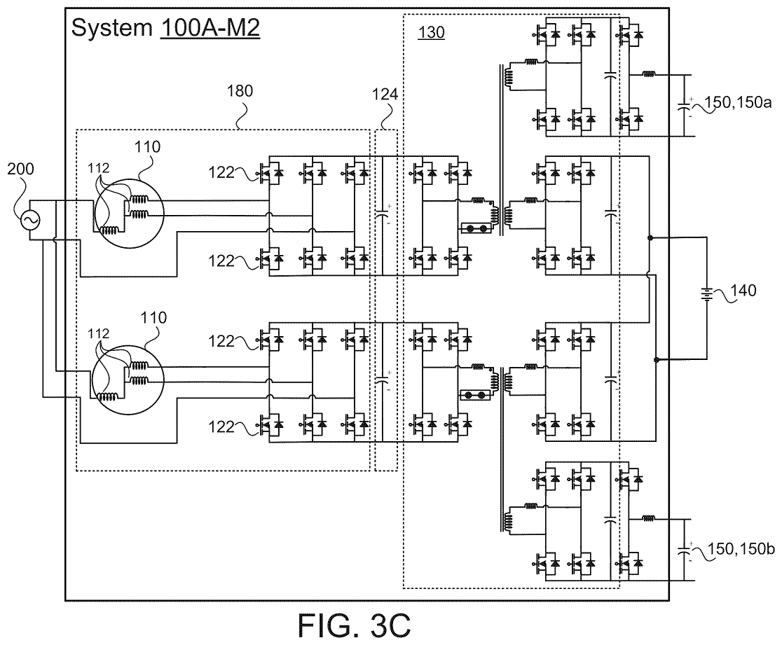

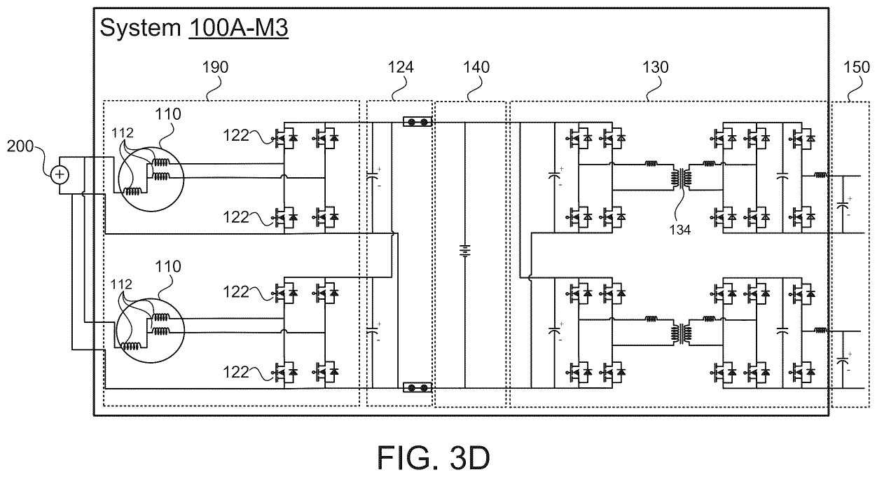

Referring to FIGS. 1-3A, the system 100 supports an 800V BEV and includes a motor 110, a traction inverter 120, and a three port DC-DC converter 130. As can be seen in FIG. 2B, in some examples, the system 100 includes two motors 110, 110a, 110b two traction inverters 120, 120a, 120b, and two DC-DC converters 130, 130a, 130b. By having dual modules, the system 100 can increase maximum charging power, increase the system reliability by fulfilling system redundancy requirements, and increase charging performance at partial load. The system 100 may be adjusted and reconfigured to accommodate several vehicle architectures and requirements as will be discussed in FIGS. 3A-16B.

FIG. 3A shows a system 100A having at least two traction motors 110, 110a, 110b. In this case, each traction motor 110, 110a, 110b is a conventional three-phase Y-connected motor. A traction motor 110 is used to convert stored electrical energy (e.g., from a HV battery 140, i.e., 800V) to mechanical energy causing the vehicle 10 to move. In some examples, the traction motor 110 requires AC power to operate, as such a traction inverter 120 is used to convert the DC power from the battery source i.e., HV battery 140, into a three-phase AC power. In some examples, the two motors 110 are a front traction motor 110a, and a rear traction motor 110b of a dual-motor BEV or two rear motors of a quad-motor and tri-motor BEV. The two motors may have other configurations.

In some examples, the system 100A includes two traction inverters 120, a first traction inverter 120a and a second traction inverter 120b. The traction inverter 120 is configured to convert a DC supply from the HV battery 140 into an AC current for the motors 110. In some examples, the traction inverters 120 are a front traction inverter and a rear traction inverter. In some examples, the inverter 120 is a 3-phase power module. Each traction inverter 120 includes six switches 122 configured to switch the voltage and current from high-voltage battery on and off to create the AC drive for the motor 110. In some examples, the switches are a MOSFET or IGBT. Each traction inverter 120 is electrically connected to an inverter DC-link capacitor 124. The DC-link capacitor 124 is configured to smooth out and steady DC voltage to protect the traction inverter 120 by absorbing sudden voltage increases. In some examples, the first traction inverter 120a is connected to a first DC-link capacitor bank 124a, and the second traction inverter 120b is connected to a second DC-link capacitor bank 124b.

In some implementations, the system 100A includes two DC-DC converters 130, 130a, 130b where each DC-DC converter includes an isolated DC-DC Triple active bridge (TAB). Each TAB 130, 130a, 130b includes three H-bridges 132 interlined using a three-port transformer 134, e.g., a three winding high frequency transformer (HFT). In some examples, a serial resonant converter or a combination of the TABs 130 and serial resonant converter may be used instead of the two TABs 130 shown. Each TAB 130 includes three ports. A first port is electrically connected to the DC-link 124 (Port 1), a second port is electrically connected to a high voltage battery 140 (Port 2), and a third port is connected to a low voltage load 150 (Port 3). The three ports are electrically isolated via the three-port transformer 134. Each DC-DC converter 130, 130a, 130b includes a HV DC-DC converter 136 and an auxiliary power modules (APM) 138.

The system 100 also includes a HV battery 140, such as an 800V battery and one or more LV loads 150, 150a, 150b. The HV battery 140 is a rechargeable energy storage that supplies power to the traction motor 110 of the vehicle 10 when the HV battery 140 is charged. The HV battery 140 is charged from the grid connected to the vehicle 10 during a charging state by way of the HV DC-DC converter 136. In some examples, the voltage of the HV battery 140 at the third port P3 is determined by a battery state-of-charge (SOC) which represents the percentage of charge remaining in the HV battery 140 and may be determined by way of several methods. Several methods may be used, including, but not limited to the Coulomb Counting Method which is also referred to as the Ampere-Hour counting and current integration which relies on battery current readings mathematically integrated over a usage period to calculate the SOC value. In some examples, the voltage V of the HV battery 140 is measured by a voltage sensor. The LV load 150 is used to power vehicle devices such as, but not limited to 12V Battery, battery disconnects, etc. In some examples, the LV load 150 is 400V for powering auxiliary loads such as the heating-ventilation-air conditioning (HVAC).

The system 100 also includes a first relay S_{DC+} and a second relay Soc-. A relay is an electrically operated switch that commonly uses a coil to operate its internal switching mechanism. The relay includes a normally open (NO) terminal, a normally closed (NC) terminal, and a common terminal. In some examples, each DC-link 124 may be electrically connected to the normally open (NO) terminal of each relay S_{DC+}, S_{DC}− which is in turn electrically connected to the HV battery 140. In this case, when the relay S_{DC+}, S_{DC}− is not powered, then the circuit to the HV battery 140 is open, while when the relay S_{DC+}, S_{DC}− is powered, then the circuit to the HV battery 140 is closed and power flows to the HV battery 140. In other examples, each DC-link 124 may be electrically connected to the normally closed (NO) terminal of each relay S_{DC+}, S_{DC}− which is in turn electrically connected to the HV battery 140. In this case, when the relay S_{DC+}, S_{DC}− is powered, then the circuit to the HV battery 140 is open, while when the relay S_{DC+}, S_{DC}− is not powered, then the circuit to the HV battery 140 is closed and power flows to the HV battery 140. In some examples, switches may be used instead of the relays S_{DC+}, S_{DC}−.

Additionally, the system 100 includes a third Relay S_{P1A} and a fourth relay S_{P1B}. The third Relay S_{P1A} is electrically connected between the TAB primary H bridge 132a and the transformer 134 in the first TAB 130, 130a, i.e., the first APM 138a. The fourth relay S_{P1B} is electrically connected between the TAB primary H bridge 132a and transformer 134 in the second TAB 130, 130b, i.e., the second APM 138b. The third relay S_{P1A} and the first relay S_{P1B} are closed during the AC charging mode to allow power flow from the DC-link 124 to the HV battery 140 and the LV load 150; and remain open during the traction and DC boost charging mode. The system 100 also includes a fifth relay S_{MA} and a sixth relay S_{MB}. The fifth relay S_{MA} is electrically connected to one of the three phases in the first motor 110, 110a, and the sixth relay S_{MB} is electrically connected to one of the three phases in the second motor 110, 110b. Relay S_{MA} and S_{MB} are closed during the traction mode, to allow power flow from the inverters 120, 120a, 120b to the traction motor 110, 110a, 110b; and remain open during the AC and DC charging modes to allow power to flow from the charging input 12 to the HV battery 140. The controller 102 controls the relays based on the inputs 12 causing the system 100 to adjust its behavior and function and execute one of the modes of operation M1, M2, M3.

In some examples, the system 100 connects to a Power Distribution Unit (PDU) box 160 supported by the vehicle 10. The PDU 160 has relays and busbars that connect to the vehicle charging connectors. The PDU 160 distributes the power from the charging station 200 to the vehicle components based on the charging mode (AC or DC).

In some examples, an input electromagnetic interference (EMI) filter (not shown) may be electrically connected between the 240 V_{AC} split phase/120 V_{AC} single phase AC grid input 12 and the motor 110. The EMI filter protects the electronics within the system 100 from damage caused by high levels of radiation emitted by other electronic equipment. Additionally or alternatively, in some examples, an output EMI filter (not shown) may be electrically connected between the LV load 150, i.e., third port of the TAB 132c, 130 and the HV battery 140 i.e., second port of the TAB 132c, 130.

### Modes of Operation

The system 100A is configured to operate under three mutually exclusive modes of operations: a first mode of operation M1 (system 100A-M1 shown in FIG. 3B), a second mode of operation M2 (system 100A-M2 shown in FIG. 3C), and a third mode of operation M3 (system 100A-M3 shown in FIG. 3D). The three modes of operation M1, M2, M3 of the system 100 are associated with four functionalities: (i) dual traction drives, (ii) single/split phase AC charging, (iii) APM for converting the high voltage from the HV battery 140 down to the LV load 150, and (iv) DC boost charging.

### First Mode of Operation: Traction Mode

FIG. 3B illustrates the system 100A-M1 operating in the first mode of operation M1. When the controller 102 detects that the input data from the input 12 is indicative of the vehicle 10 moving, i.e., driving condition, for example, from one or more sensors supported by the vehicle 10, then the controller 102 executes the first mode of operation M1. The first mode of operation M1 is only available and can only be executed when the vehicle 10 is in a driving condition. During the first mode of operation M1, the system 100A-M1 utilizes the HV battery 140 to charge and/or supply power to the LV load 150 and to supply power to the traction motor 110.

The traction inverter 120 and the DC-Link capacitor 124, together operate as a 2-level voltage source inverter which modulate the DC power from the HV battery 140 to AC power to drive the motors 110, 110a, 110b. In addition, during the first mode of operation M1 the HV battery 140 simultaneously charges the LV load 150, 150a, 150b through the dual active bridge converter formed by the second port 2 and third port 3 H-Bridges 132, 132b, 132c.

Furthermore, during the traction mode M1, the first and second relays S_{DC+}, S_{DC}− of the system 100A-M1 are closed to connect the HV battery 140 to the two DC-links 124, 124a, 124b of the two parallel traction inverters 120, 120a, 120b. The transformer 134 is galvanically connected the HV battery 140 (Port 2), and LV load 150 (e.g., LV battery or load) (Port 3). The third relays S_{P1A} and the fourth relay S_{P1B} from the top and bottom banks are disconnected i.e., open during the traction mode M1 to prevent circulating current in the Port 1 H-Bridge which could damage the switches in port 1 132a, and the DC-link capacitors 124. This allows the power to flow from the HV battery 140 to charge the LV load 150 during the first mode of operation M1 of the system 100A-M1.

### Second Mode of Operation: AC Charging Mode

FIG. 3C illustrates the system 100A-M2 operating in the second mode of operation M2. When the controller 102 detects that the input data from the input 12 is indicative of the vehicle 10 being charged by an alternating voltage source 200, such as 240 V_{AC} split phase/120 V_{AC} single phase grid, then the controller 102 executes the second mode of operation M2. The second mode of operation M2 is only available and can only be executed when the vehicle 10 is parked and being charged by a 240 V_{AC} split phase/120 V_{AC} single phase grid, i.e., the input 12 is 240 V_{AC} split phase or 120V_{AC} single phase. During the second mode of operation M2 the motor 110 and the switches 122 of the inverters 120 operate as a two-phase interleaved PFC (power factor correction) circuit configuration 180. As shown, relays S_{MA}, S_{MB}, S_{DC+}, and S_{DC}− are open, and relays S_{P1A}, S_{P1B} are closed. Each of the traction inverters 120 includes three phase legs with six switches that behave as the two-phase interleaved Totem Pole PFC circuit. Two of the inverter phase legs operate as the PFC high frequency phase legs, which operates in high switching frequency; the third inverter phase leg operates as the PFC low frequency phase leg, which operates in the grid frequency (50/60 Hz). The motor winding inductance 112 is utilized as the PFC boost coil. The PFC circuit 180 converts the AC grid voltage into DC voltage to charge the HV battery 140 and the LV load 150. In addition, the PFC circuit 180 also regulates the input power factor and current THD (Total Harmonic Distortion) to comply with the given standards. The PFC circuit 180 being a combination of the motor 110 and the traction inverter 120 eliminates the need for PFC coils, and PFC switches, utilizing the motor winding inductance 112 and traction inverter power module switches 122 to achieve significant power device reduction; Bi-directional power flow; and Dual bank configuration to fully utilize maximum charging power and fulfil system redundancy requirement.

The integration of the OBC and APM utilizes the TAB converter 130 and three-port transformer 134. The TAB 130 transfers the DC bus power to charge the HV battery 140 and LV load 150 (e.g., step down voltage) simultaneously, and the three-port transformer 134 provides galvanic isolation between the AC input 12, HV battery 140, and LV load 150. The dual bank configuration provides redundancy, which is required by some EV manufacturers. Furthermore, the TAB converter 130 also enables reverse power operation for vehicle-to-everything (V2X).

### Third Mode of Operation: DC Charging in Boost Mode

FIG. 3D illustrates the system 100A-M3 operating in the third mode of operation M3. When the controller 102 detects that the input data of the input 12 is indicative of the vehicle 10 being charged by a DC voltage source, such as a 400 V DC charging station 200, then the controller 102 executes the third mode of operation M3. The third mode of operation M3 is only available and can only be executed when the vehicle 10 is parked and being charged by a DC charging station 200, i.e., the input 12 is 400V DC. The DC boost charging functionality allows the 800 V battery 140 to be charged with a legacy 400 V DC fast charger. In this mode, relays S_{MA}, S_{MB}, S_{P1A}, and S_{P1B} are open, whereas S_{DC+}, S_{DC}− are closed as shown in FIG. 3D.

During the third mode of operation M3, the motor 110 and the two-phase legs (four switches) 122 of the inverter 120 operate as a dual interleaved boost converter 190. Since a basic boost converter converts a DC voltage to a higher voltage, the behavior of the circuit as a dual interleaved boost converter 190 reduces the inductor ripple current which in this case is the motor winding and output voltage ripple of the DC-link capacitor 124. Additionally, utilizing traction inverter power module switches 122 achieves significant power device reduction. The windings 112 of the motor 110 are utilized by the interleaved boost converter 190 such that phase U of each motor 110 is connected in series with phases V and W to form two interleaved branches of the DC boost converter 190, which operates in continuous conduction mode (CCM) mode. This configuration can be added to any existing e-drive platform design with the minimum modification. In addition, the dual bank 124 configuration achieves high power charging.

During this operating mode, i.e., third mode of operation M3, the output voltage of the electric vehicle supply equipment (EVSE) 200, i.e., the input 12, is boosted up to the HV battery voltage. In other words, the 400 V DC input 12 is boosted up to 800 V to charge the 800 V HV battery 140. The dual-bank configuration of the DC boost converter 190 provides redundancy and enables higher DC charging power. The Port 1 H-bridge that connects to the DC-link 124 of the TAB 130 is disconnected in the third mode of operation M3 by opening relays S_{P1A} and S_{P1B}, and HV battery 140 (Ports 2) and the LV load 150 (Port 3) are galvanically connected through a Dual Active Bridge (DAB) 134 circuit. This allows the LV load 150 to be charged during the DC boost charging mode by the HV battery 140. As shown, only 4 switches 122 are being used due to the DC-DC topology.

### Exemplary topologies

The following exemplary topologies are based on the system 100A described above. Each system 100B-100N may function in at least two of the three modes of operations: the first mode of operation or the traction mode M1, the second mode of operation or the AC charging mode M2, and optionally the third mode of operation or the DC charging boost Mode M3. Based on one or more inputs 12, the controller 102 determines which mode of operation M1, M2, M3 the system 100B-100N will operate in. For example, when the controller 102 receives input data at the input 12 from one or more sensors supported by the vehicle 10 and determines that the input data is indicative of the vehicle 10 being driven or moving, then the controller 102 executes the traction mode M1 of operation. During the traction mode M1, the HV battery 140 supplies power to the traction motor(s) 110 and optionally the HV battery charges and/or supplies power to the LV load(s) 150 when the system 100 includes at least one APM 138.

The AC charging mode of operation M2 is executed when the controller 102 detects that the input data from the input 12 is indicative of the vehicle 10 being parked and connected to an alternating voltage source 200, such as 240 V_{AC} split phase/120 V_{AC} single phase grid. During the AC charging mode M2 the voltage from the AC grid 200 is converter into DC voltage to charge the HV battery 140 and optionally the LV load(s) 150, when one or more APMs 138 are available. The DC boost charging mode of operation M3 is executed when the controller 102 detects that the input data of the input 12 is indicative of the vehicle 10 being parked and being charged by a DC voltage source 200, such as a 400 V DC charging station 200, then the controller 102. During the DC boost charging mode M3, the voltage of the legacy 400 V DC fast charger 200 is boosted up to charge the HV battery 140 and optionally the LV load(s) 150 when one or more APMs 138 are available.

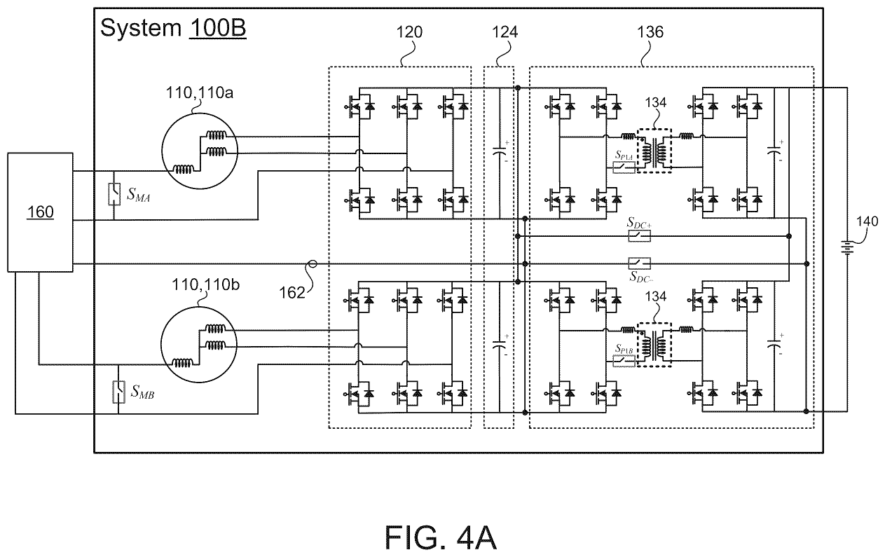

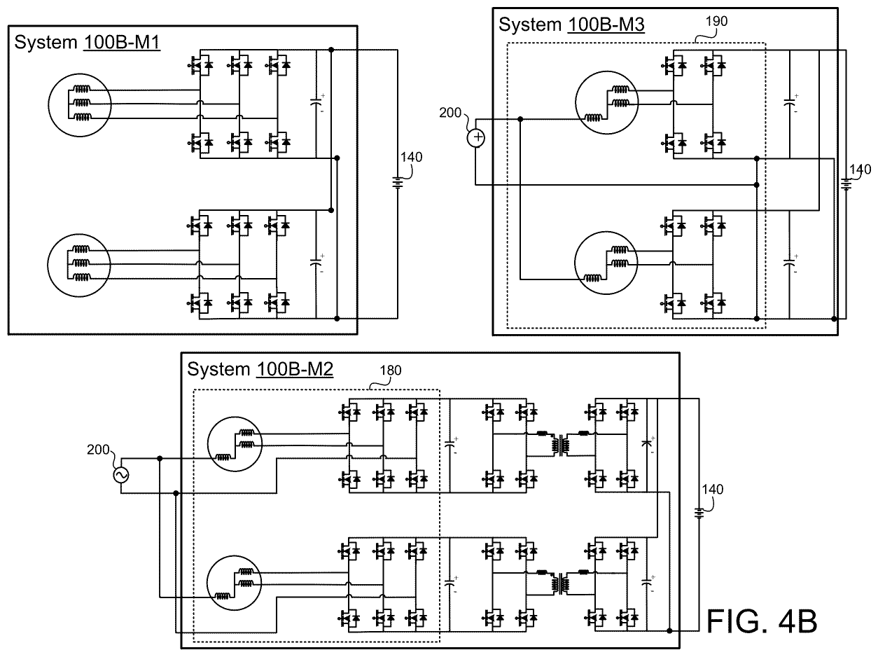

FIGS. 4A and 4B: FIG. 4A shows a system 100B, similar to the system 100A shown in FIG. 3A; however, the system 100B of FIG. 4A does not include the APM units 138, 138a, 138b where each connects to the respective LV load 150, 150a, 150b. Therefore, the system 100B has the same functionality as the system 100A of FIG. 2A except for the capability of charging the first and second LV loads 150, 150a, 150b. As can be seen, the TAB converters 130 are replaced with Dual Active Bridge converters 130, which also enable reverse power operation for vehicle-to-everything (V2X). FIG. 4B shows the first, second, and third modes of operation M1, M2, M3, which are also supported by the system 100B.

Referring to FIG. 4B, when the system 100B-M1 is operating in the traction mode M1 of operation, the HV battery 140 supplies power to the traction motor 110. When the system 100B-M2 is operating in the AC charging mode M2, the PFC circuit 180, which includes the first and second motors 110, 100a, 110b and the switches 122 of each of the first and second inverters 120, converts the AC grid voltage into DC voltage to charge the HV battery 140. When the system 100B-M2 is operating in the DC charging boost mode M3, the dual interleaved boost converters 190 boosts the voltage of the legacy 400 V DC fast charger 200 to charge the 800 V battery 140.

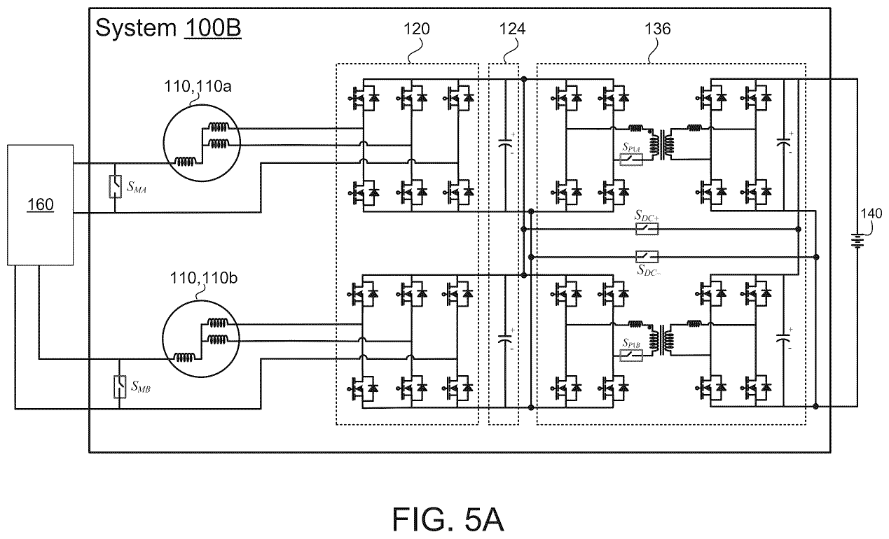

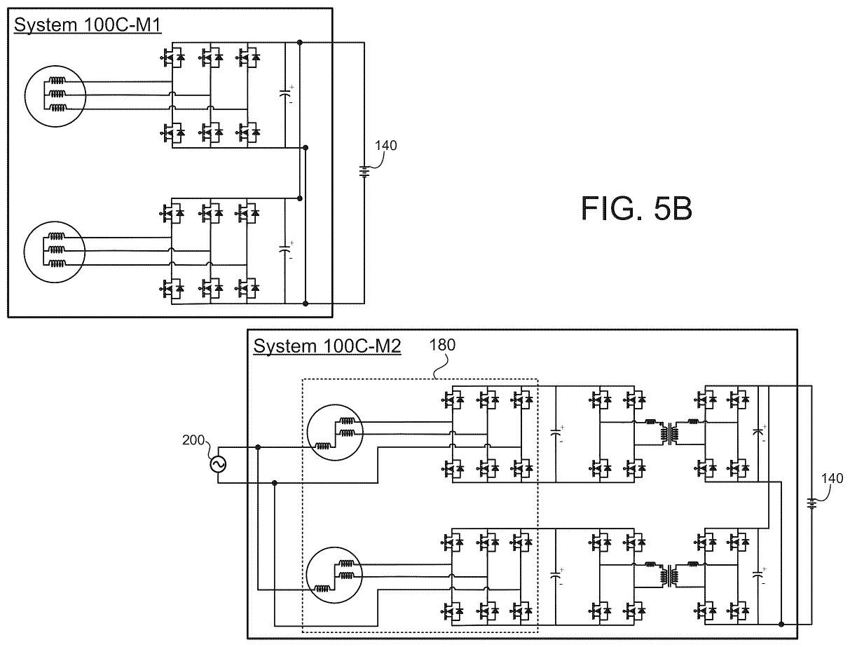

FIGS. 5A and 5B: FIG. 5A shows a system 100C similar to the system 100B shown in FIG. 4A which does not include the APM unit 138 (connecting to the LV load 150); however, this system 100C does not support the DC boost charging mode M3 since the boost connection 162 is not included. As such, this system 100C only supports two modes of operations as shown in FIG. 5B: the traction Mode M1 and the AC Charging Mode M2. The shown system 100C functionally behaves like the system 100B except for the DC boost charging mode M3. Therefore, during the traction mode M1, the HV battery 140 of the system 100C-M1 supplies power to the traction motors 110. While during the AC charging mode M2, the voltage from the AC grid 200 is converted to DC voltage to charge the HV battery 140 of the system 100C-M2.

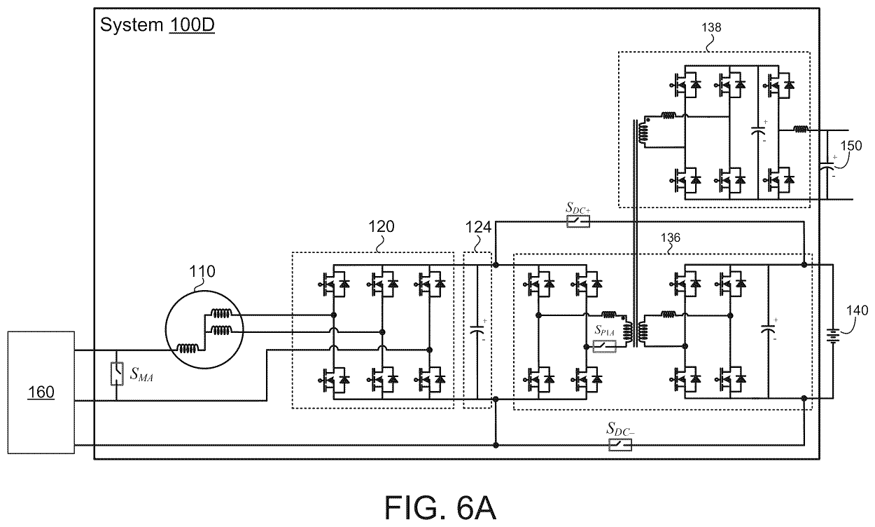

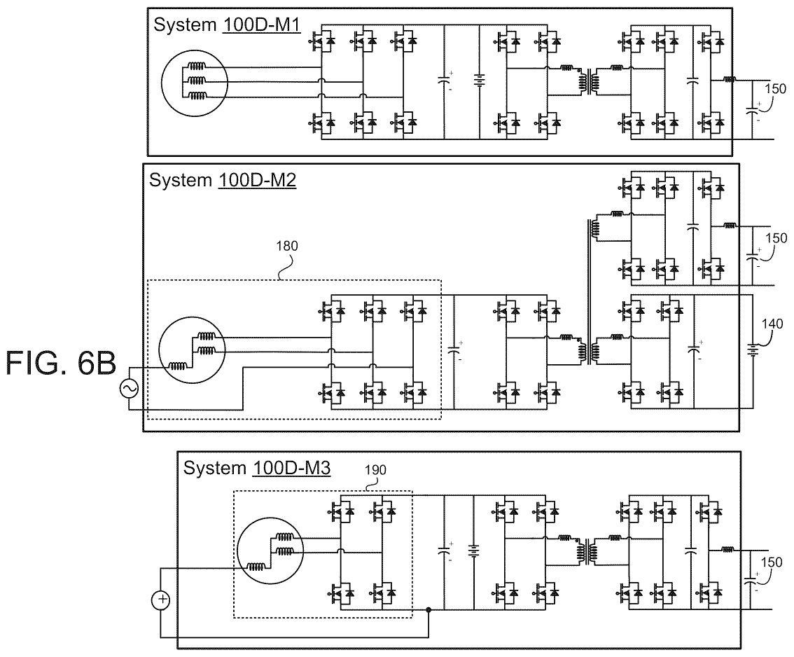

FIGS. 6A and 6B: FIG. 6A shows a system 100D having a motor 110, such as a single three-phase motor, a traction inverter 120, and one APM 138. The system 100D provides 1P charging, DC boost charging, and a single bank APM. The system 100D has the same functionality as the system 100A of FIG. 3A except for the dual functionality capability. When the system 100D-M1 is operating in the traction mode M1, the HV battery 140 supplies power to the traction motor 110. The first and second relays S_{DC+}, S_{DC}− are closed to connect the HV battery 140 to the DC-link 124 of the traction inverter 120. Also, the third relay S_{P1A} is disconnected, i.e., open, during the traction mode 100D-M1 to prevent circulating current in the Port 1 H-Bridge which could damage the switches in port 1, and the DC-link capacitors 124. When the system 100D-M2 is operating in the AC charging mode M2, the PFC circuit 180 converts the AC grid voltage into DC voltage to charge the HV battery 140 and the LV load 150. Additionally, when the system 100D-M3 is operating in the DC boost charging mode M3, the voltage of the legacy 400 V DC fast charger 200 is boosted up to charge the HV battery 140 and the LV load 150 by way of the interleaved boost converter 190.

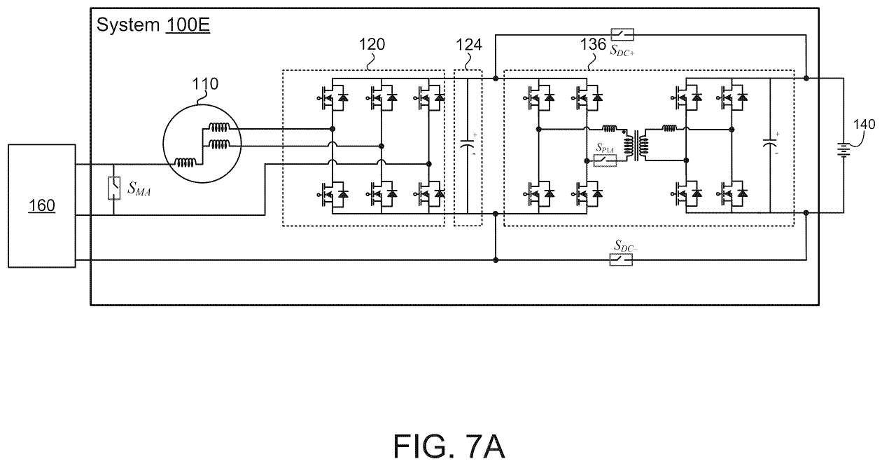

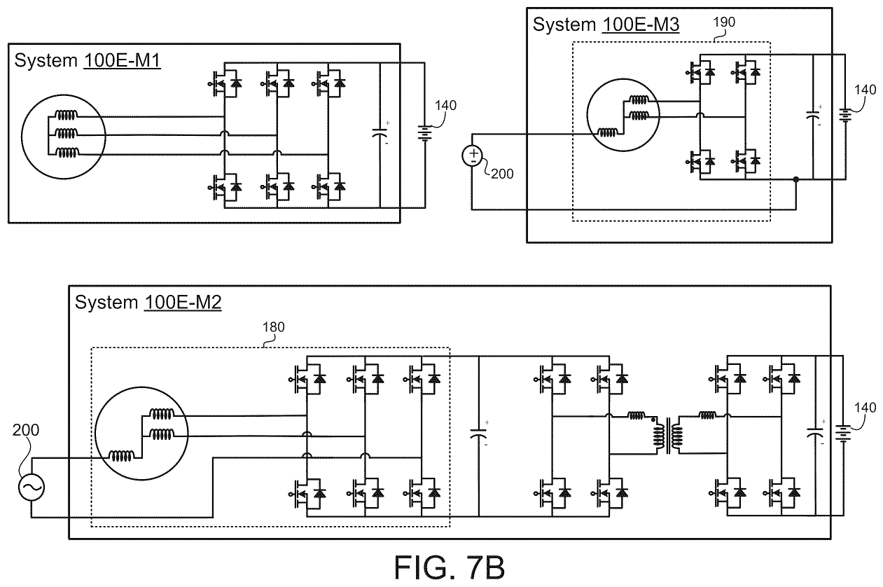

FIGS. 7A and 7B: FIG. 7A shows a system 100E based on the system 100D shown in FIG. 6A but without the APM 138. FIG. 7B shows the modes of operation that this example can operate in: Traction Mode 100E-M1, AC Charging Mode 100E-M2, and DC Boost charging mode 100E-M3. Since this system 100E does not include an APM 138, then during the AC charging mode 100E-M2, the PFC circuit 180 converts the voltage from the AC grid 200 into DC voltage to charge the HV battery 140 only. Also, during the DC boost charging mode M3, the voltage of the legacy 400 V DC fast charger 200 is boosted up to charge the HV battery 140.

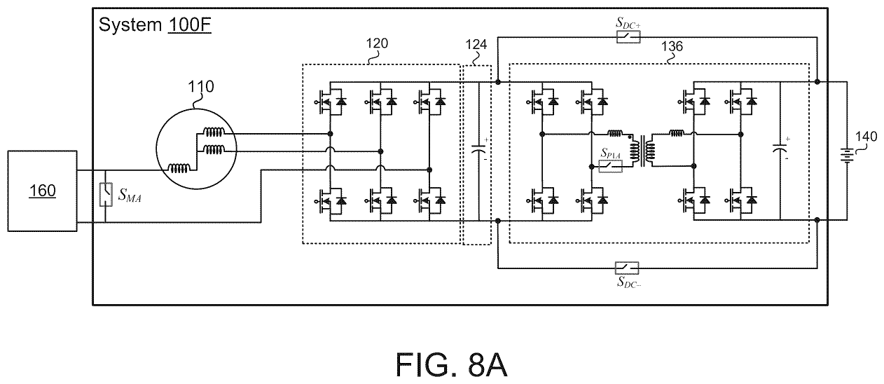

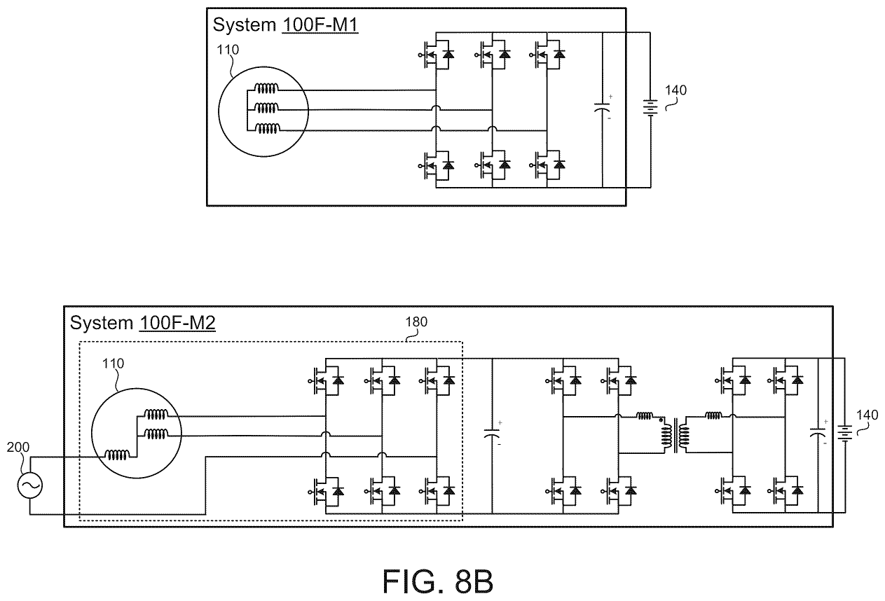

FIGS. 8A and 8B: FIG. 8A shows a system 100F based on the system 100E shown in FIG. 7A but without the boost connection 162. Therefore, the system 100F can operate in the traction mode 100F-M1 and the AC charging mode 100F-M2 shown in FIG. 8B.

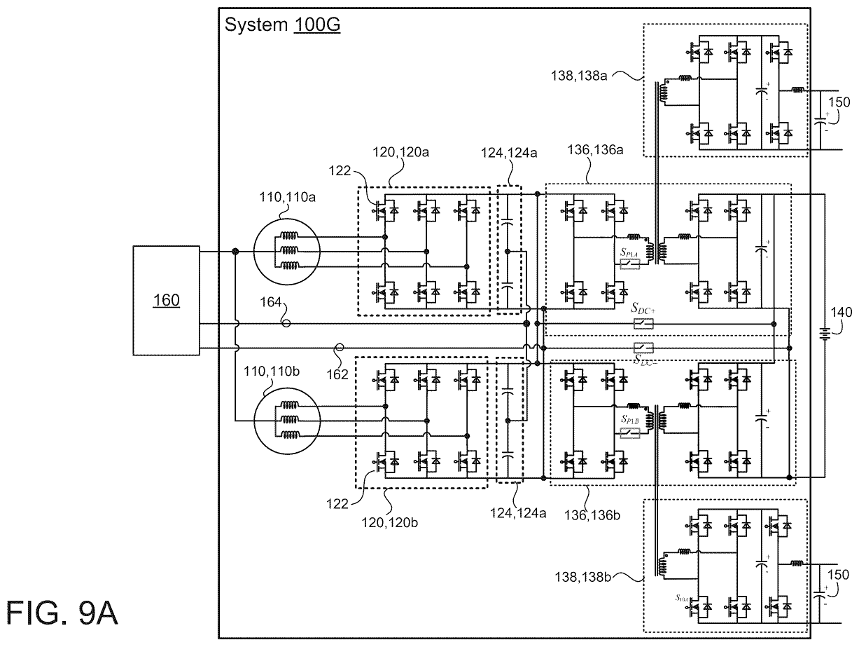

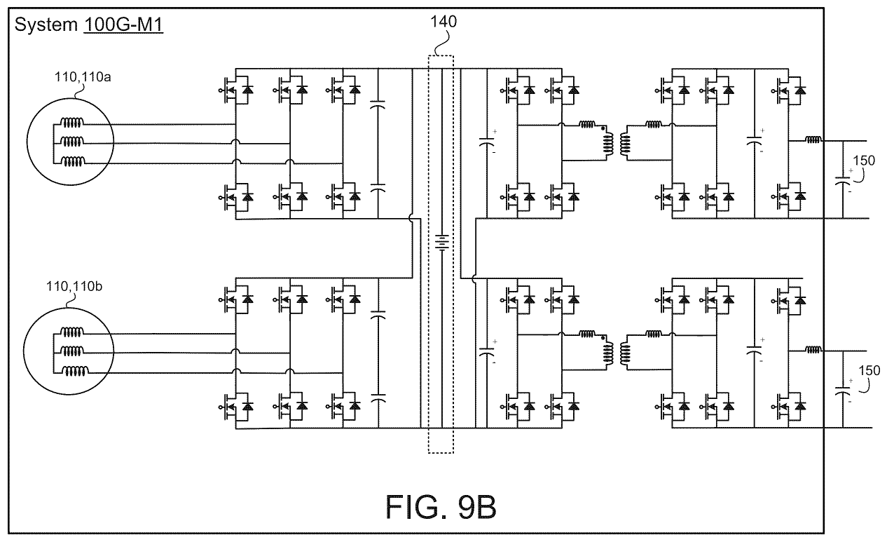

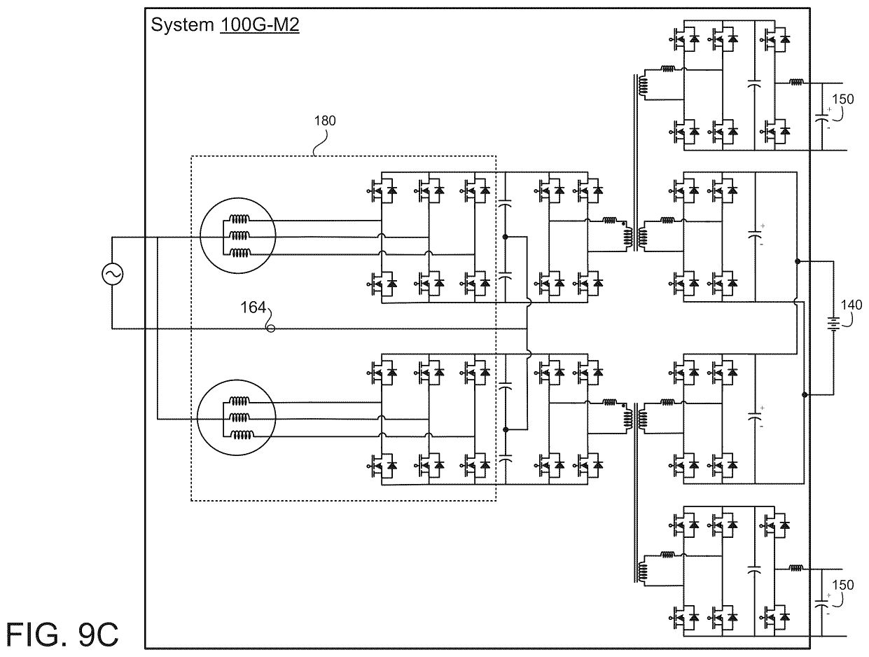

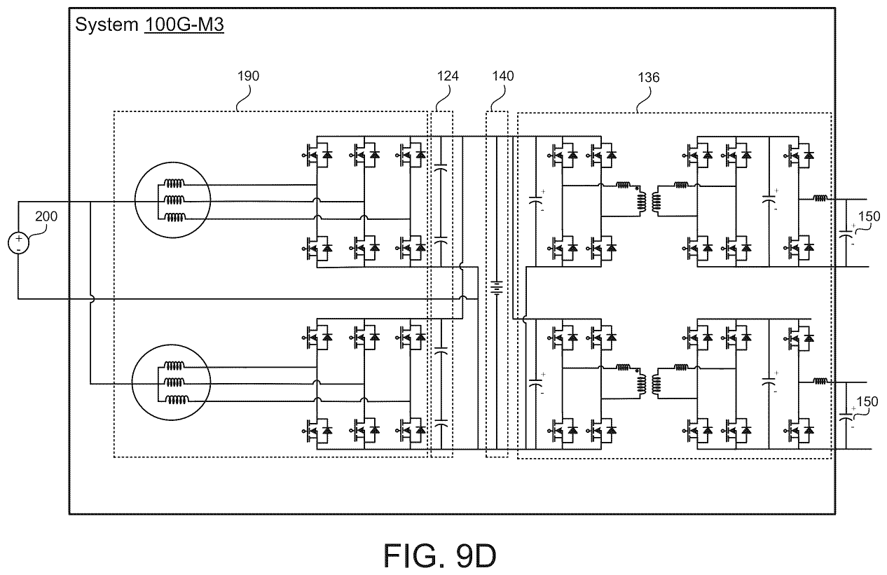

FIGS. 9A-9D: FIG. 9A shows a system 100G based on the system 100A shown in FIG. 2A but each motor 110, 110a, 110b is a three phase (3P) Y connected motor with neutral point access. In a 3 phase Y connected motor, one end of each of the three phase windings is connected together to form a common point known as the neutral point, and this neutral point is usually terminated inside the motor enclosure and is not accessible in a conventional 3 phase Y connected motor. A three phase Y connected motor with neutral point access is a specialized type of 3 phase motor that has the neutral point available to access. This system 100G utilizes this neutral point connection 164 during the AC and DC boost charging modes M2, M3 to minimize the torque production during charging, reducing the number of relays, and also increase the charging performance. Another difference relative to the system 100A of FIG. 2A is that each DC-link 124, 124a, 124b includes a split DC-link capacitor which allows the system 100G to operate in the AC charging mode M2 because the system 100G utilizes the neutral point of the 3P motor as the positive terminal for charging, and the midpoint of the split DC-link capacitor bank as the negative terminal; this connection is referred to as connection 164. During charging, the current flows into the neutral point of the 3P motor and returns from the midpoint of the split DC-link capacitor. The midpoint of the capacitor is needed due to the unique type of motor and PFC circuit used in this topology compared to the previous topologies. As shown, this system 100G includes the first relay S_{DC+}, the second relay S_{DC}, the third Relay S_{P1A}, and the fourth relay S_{P1B}. However, this system 100G does not include the fifth relay S_{MA} and the sixth relay S_{MB}. The 3P Y connected motor with neutral point access is used instead of the conventional 3P motor. This is one of the benefits of using such motors. Additionally, having the access to the motor neutral point allows a 3-phase interleaved topology for both AC and DC charging. Compared to the previously topologies, having one additional interleaving leg increases the charging efficiency, and reduces the input current Total Harmonic Distortion (THD). Moreover, the previous systems 100A-100F require a complex control strategy to eliminate torque production during charging, due to the charging current entering from one phase leg of the motor and distributed into the other two-phase legs. Allowing charging current to flow directly into the motor neutral point and distributed into all 3 phase legs of the motor does not generate any torque, thus reducing the control complexity.

When the system 100G-M1 (FIG. 9B) is operating in the traction mode M1 of operation, the HV battery 140 supplies power to the traction motor 110. When the system Mode 100G-M2 (FIG. 9C) is operating in the AC charging mode M2, the three-phase interleaved PFC circuit 180, which includes the first and second motors 110, 100a, 110b and the switches 122 of each of the first and second inverters 120, converts the AC grid voltage into DC voltage to charge the HV battery 140. When the system 100G-M3 (FIG. 9D) is operating in the DC charging boost mode M3, the three phase interleaved boost converters 190, boost the voltage of the legacy 400 V DC fast charger 200 to charge the 800 V battery 140.

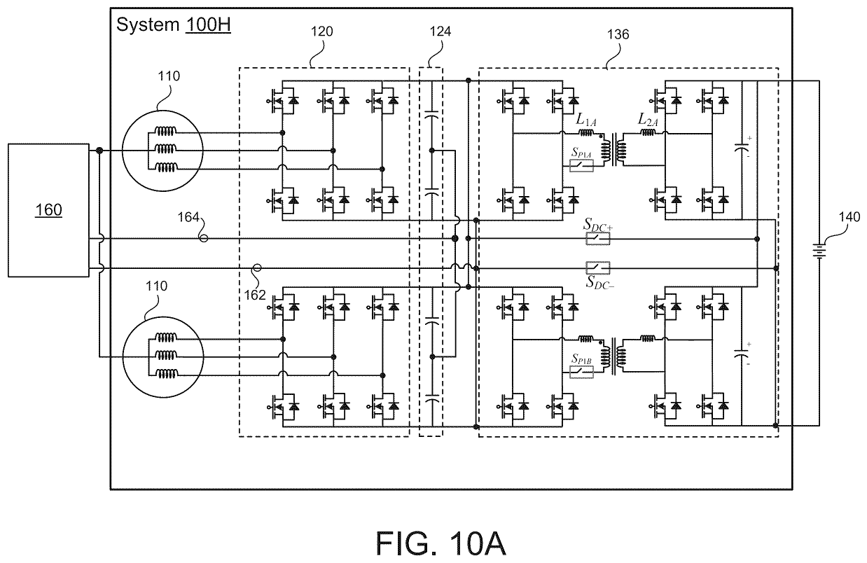

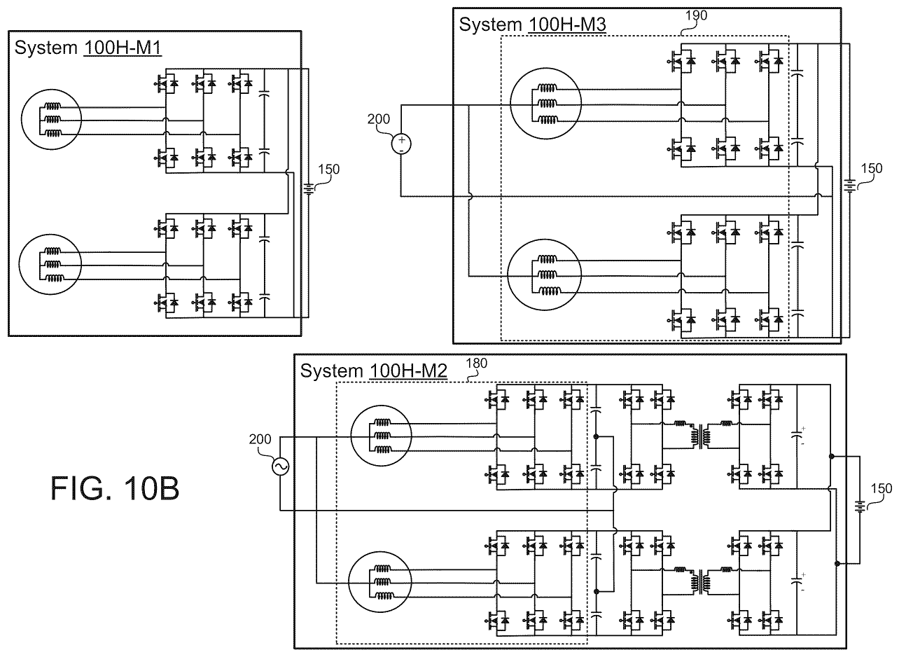

FIGS. 10A and 10B: FIG. 10A shows a system 100H based on the system 100G shown in FIG. 9A but without the APM 138. Therefore, this system 100H has the same functionality as the system 100G in FIG. 9A except for the capability of charging a LV load 150 since there is no APM 138. As can be seen, the TAB converters 130 are replaced with Dual Active Bridge converters 130, which also enable reverse power operation for vehicle-to-everything (V2X). FIG. 10B shows the first, second, and third modes of operation M1, M2, M3. Since this system 100H does not include an APM 138, then during the AC charging mode 100H-M2, the three-phase interleaved PFC circuit 180 converts the voltage from the AC grid 200 into DC voltage to charge the HV battery 140 only. Also, during the DC boost charging mode M3, the voltage of the legacy 400 V DC fast charger 200 is boosted up to charge the HV battery 140 by way of the three phase interleaved boost converters 190.

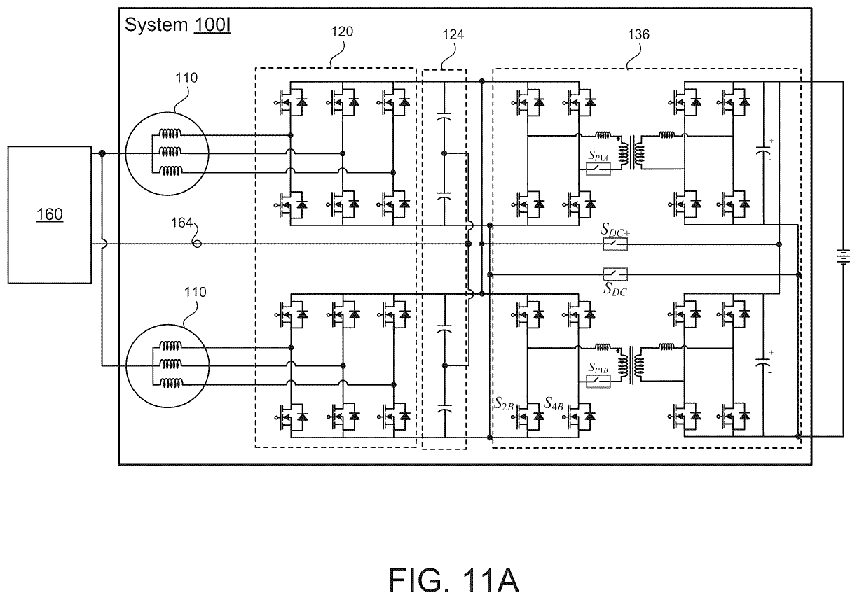

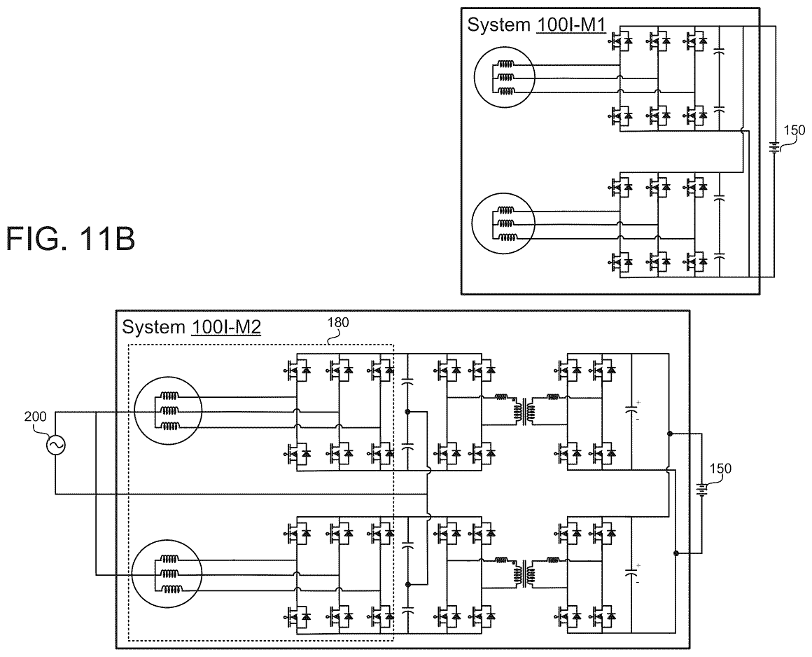

FIGS. 11A and 11B: FIG. 11A shows a system 100I based on the system 100H shown in FIG. 10A but without the boost connection 162. Since this topology does not include the boost connection 162, then the system 100I can only operate in the Traction Mode 100I-M1 and the AC Charging Mode 100I-M2 as shown in FIG. 11B.

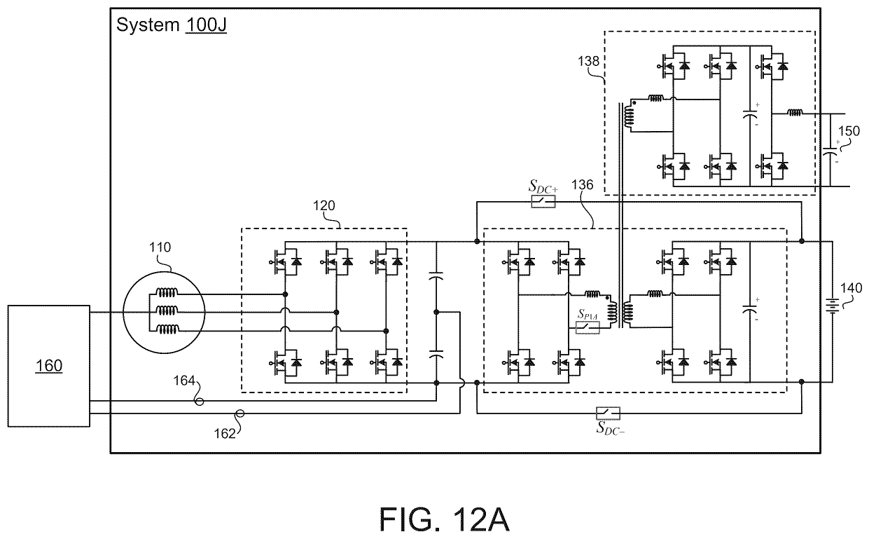

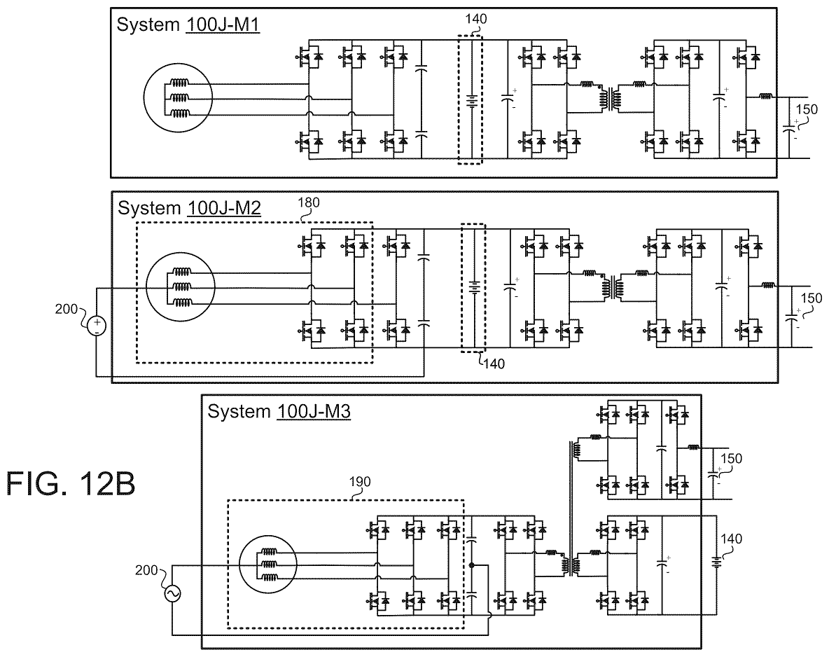

FIGS. 12A and 12B: FIG. 12A shows a system 100J based on the system 100G shown in FIG. 9A; however, this system 100J includes only one inverter 120 and one motor 110 (single bank). This system 100J provides 1P/split phase charging. FIG. 12B shows the modes of operation that this example can operate in: Traction Mode 100J-M1, AC Charging Mode 100J-M2, and DC Boost charging mode 100J-M3.

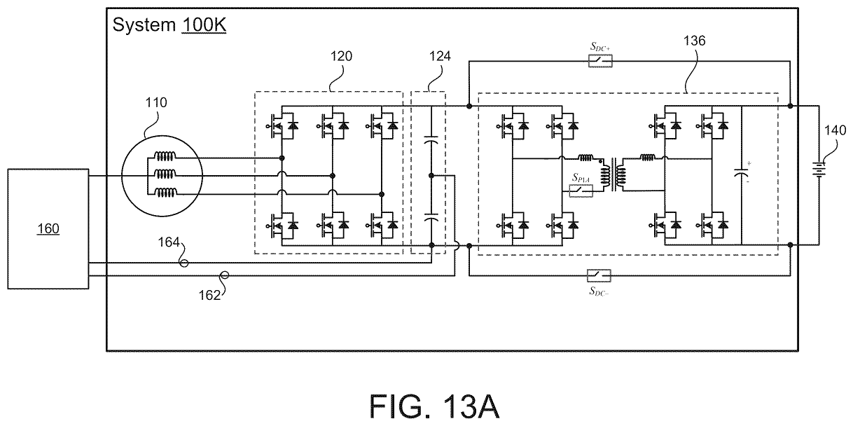

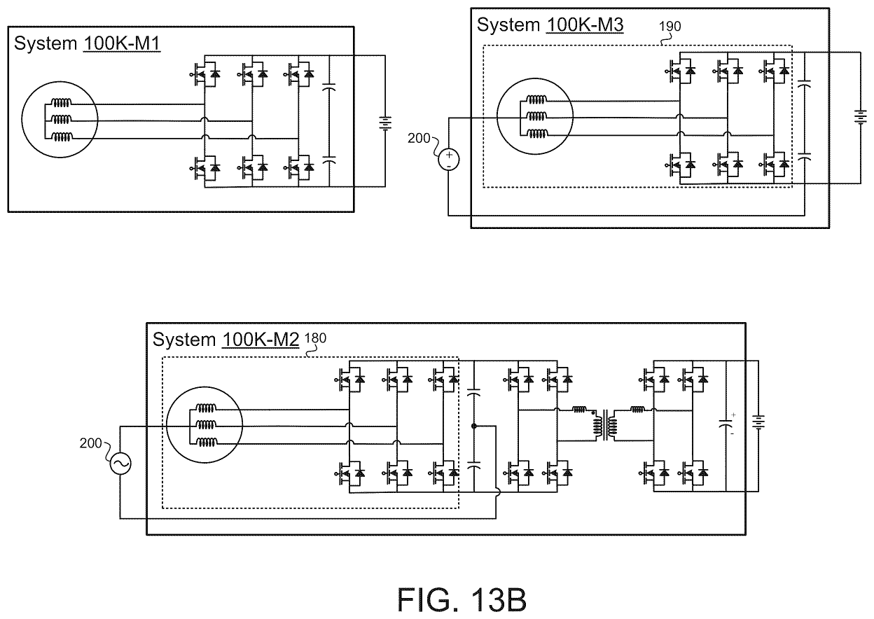

FIGS. 13A and 13B: FIG. 13A shows a system 100K based on the system 100J shown in FIG. 12A; however, this system 100K does not include the APM module 138. Therefore, this system 100K has the same functionality as the system 100J in FIG. 12A except for the capability of charging an LV load 150 since the APM module 138 is not present. FIG. 13B shows the modes of operation that this example can operate in: Traction Mode 100K-M1, AC Charging Mode 100K-M2, and DC Boost charging mode 100K-M3. Since the APM 138 is not included in this system 100K, during the AC Charging Mode 100K-M2 and the DC Boost charging mode 100K-M3, only the HV battery 140 is charged.

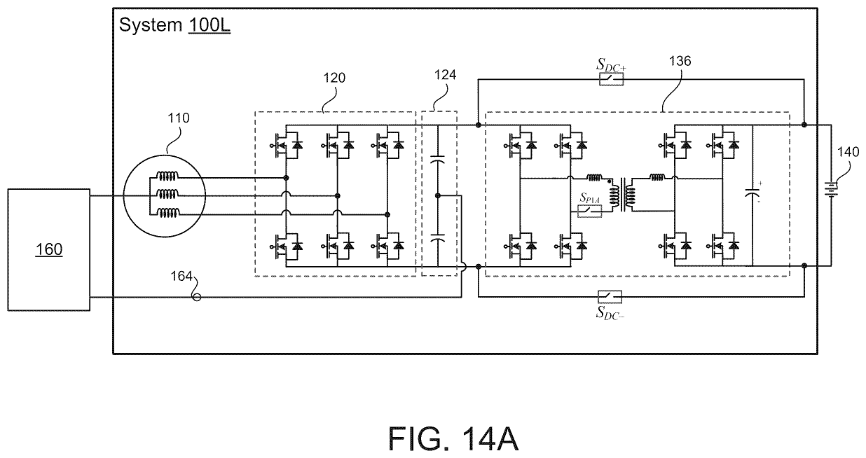

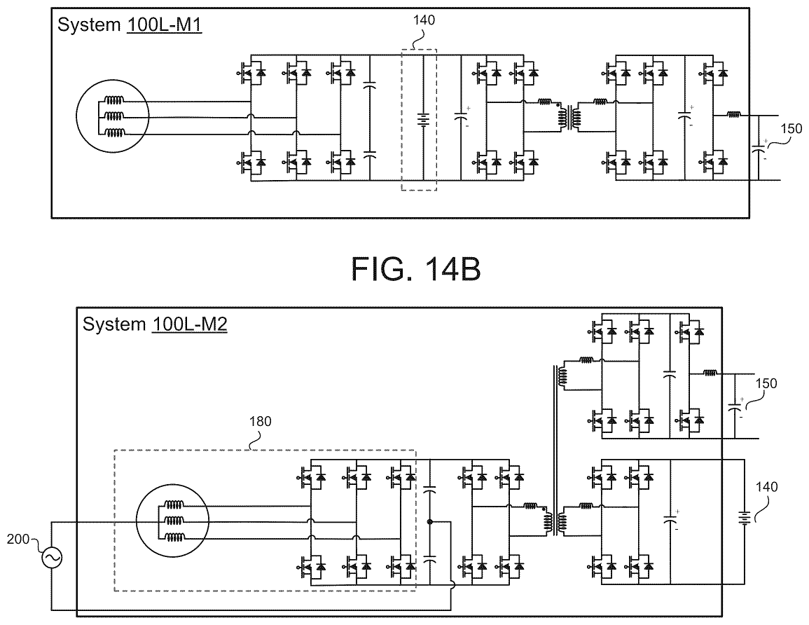

FIGS. 14A and 14B: FIG. 14A shows a system 100L based on the system 100K shown in FIG. 13A without the DC boost connection 162. Since this system 100L does not include the boost connection 162, then the system 100L can only operate in the Traction Mode 100L-M1 and the AC Charging Mode 100L-M2 as shown in FIG. 14B.

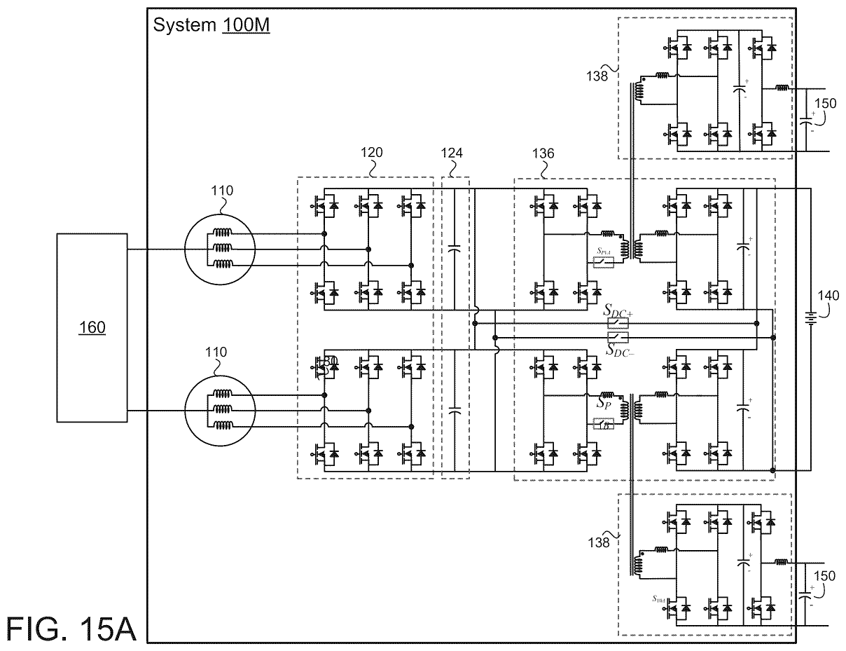

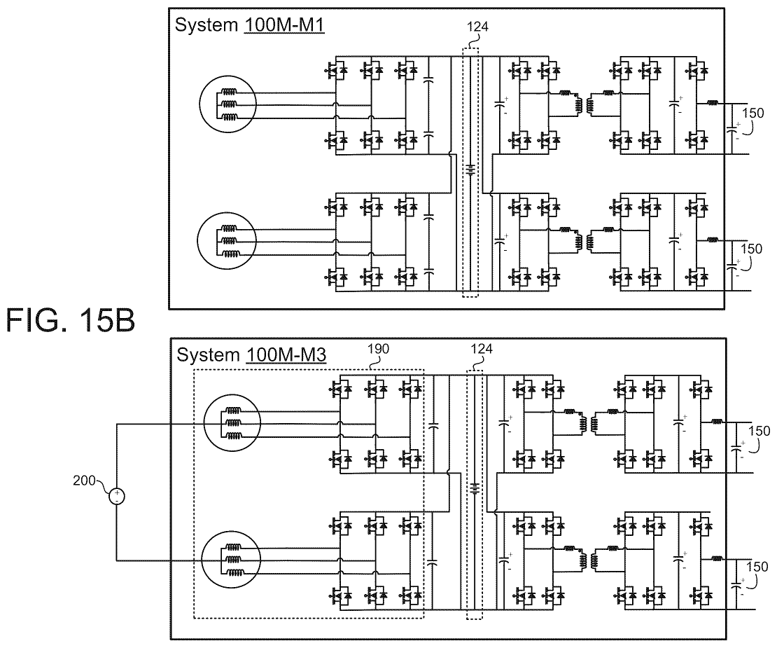

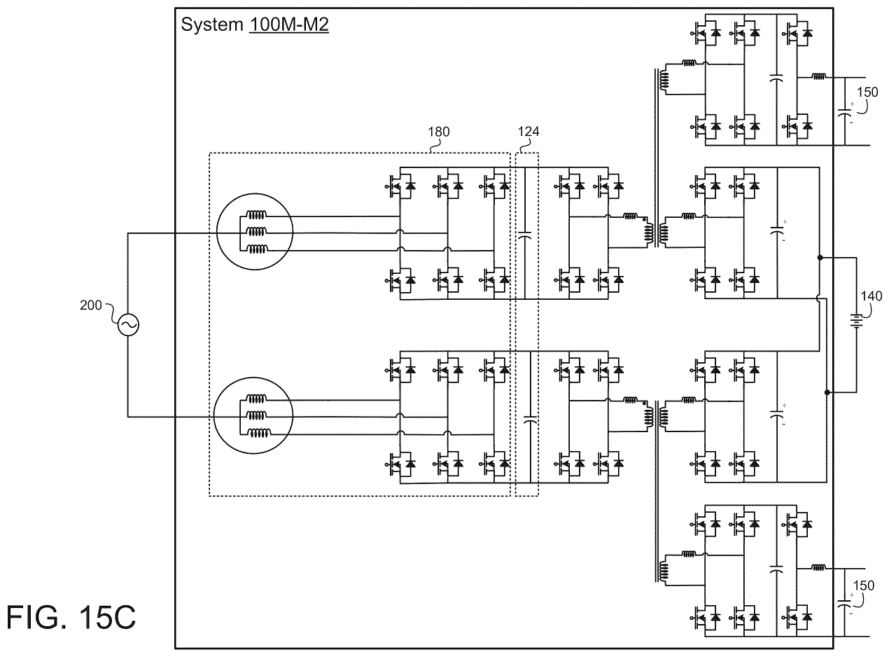

FIGS. 15A and 15B: FIG. 15A shows a system 100M based on the system 100G shown in FIG. 9A; however, this system 100M does not include a split DC-link 124 but merely a single DC-link for each inverter 120. The two banks of PFCs/DC Boost Converters are connected in series rather than parallel. During the AC charging mode 100G-M2 and the DC charging mode 100G-M3, the inputs 12 are connected to the two DC banks 124 in series. The current will flow into the first motor 110, first inverter 120, and then into the second inverter 120, and finally returns from the second motor 110.

Although this system 100M does not include the boost connection 162, the DC boost charger shares the same input as the AC charger, allowing for the system 100M to function in the three modes of operation: traction mode 100M-M1, Ac charging mode 100M-M2, and DC boost charging mode 100M-M3 as can be seen in FIGS. 15B and 15C.

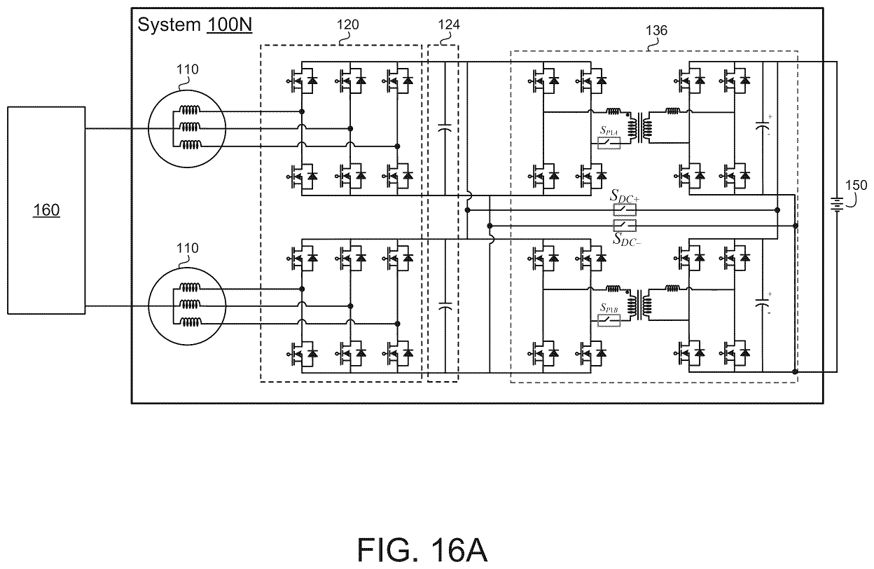

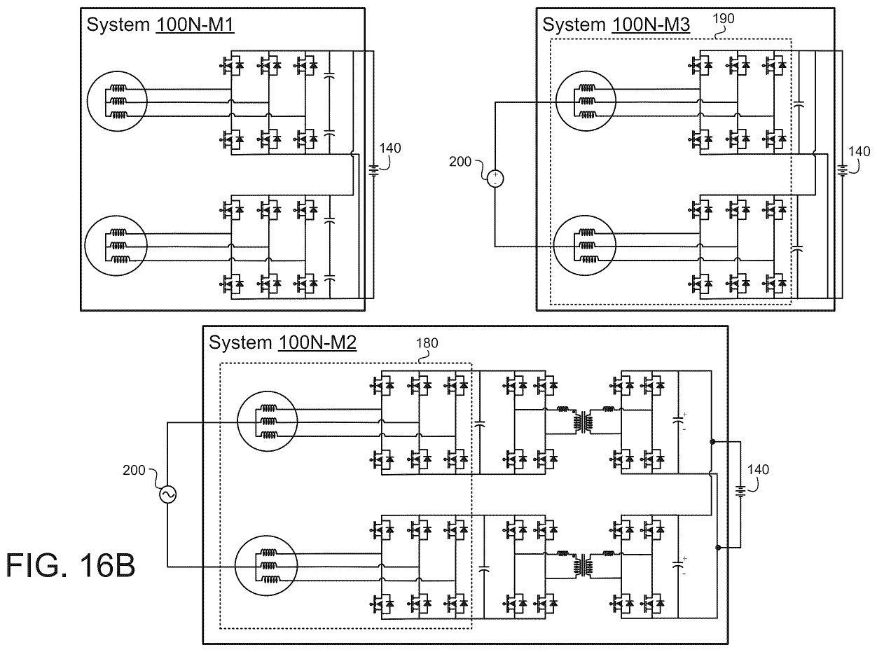

FIGS. 16A and 16B: FIG. 16A shows a system 100N based on the system shown in FIG. 15A but without the APM module 138. Therefore, this system 100N has the same functionality as the system 100M in FIG. 15A except for the capability of charging the LV load 150 since an APM 138 is not connected. Additionally, this system 100N can operate in the three modes of operation 100N-M1, 100N-M2, 100N-M3. Since the APM 138 is not included in this system 100N, during the AC Charging Mode 100N-M2 and the DC Boost charging mode 100N-M3, only the HV battery 140 is charged.

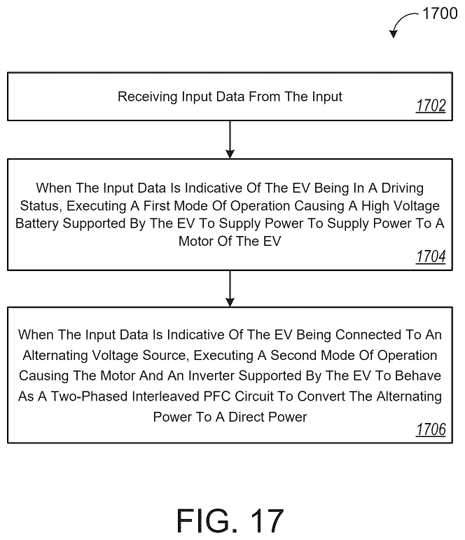

FIG. 17 provides an example arrangement of operations for a method 1700 for operating the system described in FIGS. 1-16B based on an input 12 received by the system 100. At block 1702, the method 1700 includes receiving input data from the input 12. In some examples, the input data includes at least one of a voltage sensor data, a current sensor data, and vehicle motion sensor data. When the input data is indicative of the EV 10 being in a driving status, the method 1700 at block 1704 includes executing a first mode of operation M1 (Traction mode) causing a high voltage battery 140 supported by the EV 10 to supply power to supply power to the motors 110, 110a, 110b of the EV 10. In some examples, where the system 100 includes one or more low voltage loads 150, 150a, 150b, then the high voltage battery 140 also supplies power to the LV load 150. When the input 12 is indicative of the EV 10 being connected to an alternating voltage source 200, the method 1700 at block 1706 includes executing a second mode of operation M2 (AC charging mode) causing the motor 110, 110a, 110b and an inverter 120, 120a, 120b supported by the EV 10 to behave as a two-phased interleaved PFC circuit 180, 180a, 180b to convert alternating power from the voltage source 200 to direct power. In this mode of operation M2, the direct power is used to charge the HV battery 140 and when available the one or more LV loads 150. In some examples, where the topology of the system 100 supports DC boost charging, then when the input 12 is indicative of the EV 10 being connected to a direct voltage source 200, such as a 400V DC, the method 1700 includes executing a third mode of operation M3 (DC boost charging mode) causing the motor 110, 110a, 110b and the inverter 120, 120a, 120b to behave as a two-phased interleaved boost converter circuit 190 to boost the direct power from the direct voltage source 200. In this mode of operation M3, the boosted direct power is used to charge the HV battery 140 and when available the one or more LV loads 150. The first, second, and third modes of operation (M1, M2, M3) are mutually exclusive.

In some examples, the two-phased interleaved boost converter circuit 190, 190a, 190b includes a first two-phased interleaved boost converter circuit 190a and a second two-phased interleaved boost converter circuit 190b to boost the direct voltage. The two-phased interleaved PFC circuit 180, 180a, 180b includes a first two-phased interleaved PFC circuit 180a and a second two-phased interleaved PFC circuit 180b.

In some examples, the first mode of operation causes the high voltage battery 140 to supply power to an additional motor 110b of the EV 10.

The system 100 and method 1700 described provide highly integrated power electronics system for EVs. Different power electronics conversions inside the EV are integrated into one system 100 in one box to save costs and achieve volume reduction. Firstly, the most market adopted three phase Y-connected motor without the neutral terminal is used in the system 100, without any modification or specialization. The three-phase motor windings 112 are used in the system 100 for realizing the PFC coil for front end PFC converter of OBC and inductors for an interleaved boost converter for DC boost charging. Secondly, an integrated isolation transformer for DC-DC conversion is described with three ports, such that two secondary output ports were shown in the design for HV DC-DC conversion and for LV DC-DC conversion. Thirdly, dual bank architecture offers system redundancy.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

1. A system operating in at least two modes of operation based on an input, the system supported by an electric vehicle (EV), the system comprising:
an input receiving input data from one or more sensors;
a motor;
an inverter connected to the motor;
an inverter DC-link capacitor connected to the inverter; and
a DC-DC converter connected to the DC-link capacitor and a high voltage battery.

2. The system of claim 1, wherein the DC-DC converter includes an isolated DC-DC dual active bridge (TAB) having two bridges, a first bridge connected to the DC-link capacitor, a second bridge connected to the high voltage battery.

3. The system of claim 1, further comprising: a low voltage load
wherein the DC-DC converter includes an isolated DC-DC Triple active bridge (TAB) having three bridges, a first bridge connected to the DC-link capacitor, a second bridge connected to a low voltage load, and a third bridge connected to the high voltage battery.

4. The system of claim 3, wherein when the input data is indicative of the EV being in a driving status, the high voltage battery supplies power to the low voltage load and to the motor during a traction mode of operation.

5. The system of claim 1, wherein:
the motor includes a first motor and a second motor;
the inverter includes a first inverter and a second inverter;
the DC-link capacitor includes a first DC-link capacitor and a second DC-link capacitors; and
the isolated DC-DC Triple active bridge (TAB) includes a first isolated DC-DC TAB and a second isolated DC-DC TAB.

6. The system of claim 1, wherein when the input data is indicative of the EV connected to an alternating voltage source, the motor and the inverter behave as a two-phased interleaved PFC circuit to convert alternating power from the alternating voltage source to direct power during an AC charging mode of operation.

7. The system of claim 1, wherein when the input data is indicative of the EV connected to a direct voltage source, the motor and the inverter behave as a two-phased interleaved boost converter circuit to boost direct power from the direct voltage source during a DC boost charging mode of operation.

8. The system of claim 1, wherein the motor is a 3-Phase motor with neutral access point.

9. The system of claim 8, wherein the DC-link capacitor is a split DC-link capacitor.

10. The system of claim 1, wherein the one or more sensors include voltage sensor, current sensors, and vehicle motion sensor.

11. A method of operating a system in at least one of two modes of operation based on an input to the system the system supported by an electric vehicle (EV), the method comprising:
receiving input data from the input;
when the input data is indicative of the EV being in a driving status, executing a first mode of operation causing a high voltage battery supported by the EV to supply power to a motor of the EV; and
when the input data is indicative of the EV being connected to an alternating voltage source, executing a second mode of operation causing the motor and an inverter supported by the EV to behave as a two-phased interleaved PFC circuit to convert alternating power from the alternating voltage source to direct power.

12. The method of claim 11, further comprising when the input data is indicative of the EV being connected to a direct voltage source, executing a third mode of operation causing the motor and the inverter to behave as a two-phased interleaved boost converter circuit to boost direct power from the direct voltage source.

13. The method of claim 12, wherein during the third mode of operation, the high voltage battery is being charged by way of the direct power.

14. The method of claim 12, wherein the modes of operation are mutually exclusive.

15. The method of claim 12, wherein the two-phased interleaved boost converter circuit includes a first two-phased interleaved boost converter circuit and a second two-phased interleaved boost converter circuit.

16. The method of claim 11, wherein the first mode of operation causes the high voltage battery to supply power to one or more low voltage loads supported by the EV.

17. The method of claim 11, wherein the two-phased interleaved PFC circuit includes a first two-phased interleaved PFC circuit and a second two-phased interleaved PFC circuit.

18. The method of claim 11, wherein the input data includes at least one of voltage sensor data, current sensor data, and vehicle motion sensor data.

19. The method of claim 11, wherein the first mode of operation causes the high voltage battery to supply power to an additional motor of the EV.
